(19) United States
(12) Patent Application Publication
(10) Pub. No.: US 2014/0214396 A1
(43) Pub. Date: Jul. 31, 2014

(54) Specification properties creation for a visual model of a system

(71) Applicant: INTERNATIONAL BUSINESS MACHINES CORPORATION, Armonk, NY (US)

(72) Inventors: Allon Adir, Kiryat Tivon (IL); Natalia Razinkov, Or-Aqiva (IL); Tamer Salman, Haifa (IL); Karen Yorav, Haifa (IL)

(73) Assignee: International Business Machines Corporation, Armonk, NY (US)

(21) Appl. No.: 13/751,172

(22) Filed: Jan. 28, 2013

(51) Int. Cl. G06F 17/50

(52) U.S. Cl. CPC G06F 17/5009
USPC 703/21

(57) ABSTRACT

A method, system and computer program product for creation of specification properties for a visual model of a system. The specification properties are useful for verification of a verification model corresponding to the visual model. The computer-implemented method comprising automatically generating, by a processor, a specification property for a verification model based on a selection by a user of at least one element in a visual model, wherein the visual model defines a computerized system, wherein the verification model corresponds to the visual model.

### TECHNICAL FIELD

The present disclosure relates modeling of system using visual modeling tools in general, and to verification of the modeled systems, in particular.

### BACKGROUND

Model-Driven Design (MDD) is a system development methodology which focuses on creating and exploiting models of a computerized system, such as implemented in hardware or software. The model may be defined using a visual model language, such as for example Unified Modeling Language (UML), System Modeling Language (SysML), or the like. MDD tools include, for example, IBM's Rhapsody™ or org.eclipse.uml2™-based tools for embedded software and systems engineering.

The modeling language may be used to define a set of diagrams, such as but not limited to structure diagram (e.g., class diagram, component diagram, object diagram, or the like), behavior diagram (e.g., activity diagram, state machine diagram, statechart diagram, or the like) and interaction diagrams (e.g., Communication diagram, Sequence diagram, Timing diagram or the like). Structure diagrams may be representing the structures used in the system. Behavior diagrams emphasize behavior and functionality of the system. Interaction diagrams emphasize the flow of control and data among elements in the system being modeled.

In system engineering there is a knowledge gap between designers of the system and Verification, Validation and Testing (VVT) engineers of the system. Creation of specification properties useful for VVT may not be trivial and usually requires very specific knowledge and mathematical background. In some cases, specification properties are defined using languages such as Property Specification Language (PSL) and may make use of temporal logic. As a result, the designers are only in charge of designing the model and Quality Assurance (QA) thereof is sometimes performed by a different engineer.

### BRIEF SUMMARY

One exemplary embodiment of the disclosed subject matter is a computer-implemented method comprising automatically generating, by a processor, a specification property for a verification model based on a selection by a user of at least one element in a visual model, wherein the visual model defines a computerized system, wherein the verification model corresponds to the visual model.

Another exemplary embodiment of the disclosed subject matter is a system having a processor, the processor being adapted to perform the steps of: automatically generating, by a processor, a specification property for a verification model based on a selection by a user of at least one element in a visual model, wherein the visual model defines a computerized system, wherein the verification model corresponds to the visual model.

Yet another exemplary embodiment of the disclosed subject matter is a computer program product comprising a non-transitory computer readable medium retaining program instructions, which instructions when read by a processor, cause the processor to perform a method comprising: automatically generating, by a processor, a specification property for a verification model based on a selection by a user of at least one element in a visual model, wherein the visual model defines a computerized system, wherein the verification model corresponds to the visual model.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter;

FIG. 2 shows a block diagram of a machine, in accordance with some exemplary embodiments of the disclosed subject matter; and

FIGS. 3A and 3B show illustrations of GUIs, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In the present disclosure the term “verification” refers to generally any QA activity of a system based on a model thereof, such as but not limited to verification, validation, model checking, formal verification, testing and the like. The model based on which the verification is performed is referred to as a “verification model”.

In the present disclosure the term “visual model” refers to a model depicting the system which is provided in a visual manner, such as using diagrams, graphical representations, or the like. Visual models may be, for example, models defined using UML or similar visual modeling languages.

One technical problem dealt with by the disclosed subject matter is enabling a non-expert user to define specification properties useful for verifying a visual model.

Nowadays there is a crucial need in safety-critical systems that the designers will be able to specify, write and verify certain properties early in their design process. However, designers are often not experts in the field of verification and may not be proficient in the languages used to define the specification property. As an example, in order to define the specification property one might be required to know Computational Tree Logic (CTL), Linear Temporal Logic (LTL), or a similar temporal language.

One technical solution is a user-guided automatic or semi-automatic specification property generation. The generation may be based on a user selection of visual elements in the visual model.

Based on selections by the user a specification property is generated. The specification property is based on a template specification property selected from a repository of templates. The repository may comprise a plurality of parameterized templates. Based on the selections by the user and parameters of the templates, relevant templates may be determined. In some exemplary embodiments, a plurality of templates may be deemed relevant and the user may select a template to be used for the generation of the specification property.

In some exemplary embodiments, the specification property may be defined over the modeling language, such UML, and not over a verification model, such as a General Description Language (GDL), SystemC, Verilog, or the like.

In some exemplary embodiments, the user may manually edit the specification property over the modeling language. The user may manually define relationships between elements (e.g., an attribute being larger than a constant, a first condition implying a second condition, or the like), may change an order of the element, may introduce parentheses into the specification property, or the like.

Based on the visual model a verification model may be synthesized. The verification model may represent a single element of the visual model using several elements of the verification model. As an example, an integer of the visual model may be represented using a plurality of bits in a GDL model. The specification property may also be synthesized to be applicable over the verification model and useful for in verification thereof. In some exemplary embodiments, the synthesized specification property may be defined in PSL or similar specification language that may or may not support temporal logic. In some exemplary embodiments, model checking may be performed with respect to the specification property. Additionally or alternatively, a checker may be used to dynamically validate an assertion specification property. Additionally or alternatively, simulation-based verification may be used to simulate the system modeled by the model and verify the specification property during the simulation. Other verification methods may make use of the specification property.

In some exemplary embodiments, the disclosed subject matter may be incorporated into a Graphical User Interface (GUI) of a modeling tool for defining the visual model. The GUI may be responsive to a user selection of elements of the model and provide suggestions of relevant specification properties. The user may define specifications properties over the model and instruct the tool to verify the properties. In response to such instruction, the tool may synthesize the verification model and specification properties over the verification model and verify the properties using a verification tool, such as but not limited to a simulator, a checker, a model checker, or the like. In some exemplary embodiments, the GUI may provide a report of the results of the verification process, such as indicating which properties were proven, which properties were falsified (and providing a counter-example exemplifying the falsification), or the like. In some exemplary embodiments, verification of some properties may fail due to technical reasons, such as due to state-space explosion of a model checker, and indication of such a failure may be reported to the user in the GUI.

In some exemplary embodiments, the specification properties over the verification model may be based on signals, variables or flags that are implemented in the synthesized verification model but are inherent in the visual model. Such signals may be, for example, a dead state signal indicating no applicable outgoing transition from a state in a given cycle, a non-deterministic choice signal indicating a plurality of applicable outgoing transitions from a state in a given cycle requiring a non-deterministic choice between them, or the like.

One technical effect of the disclosed subject matter is allowing a designer having no verification-specific skills to define specification properties for the verification process of the designed model. The designer may have knowledge of the specifics of the system and therefore may be well suited to provide with important observations as to which specification properties to verify. However, the designer may not be proficient in temporal logic, PSL semantics, the implementation details of the verification model, and other verification-related knowledge fields.

Another technical effect of the disclosed subject matter is to allow decreasing time invested in verification and increasing productivity of the designer by simplifying the process of specification property creation.

In some exemplary embodiments, more specification properties can be created. Additionally or alternatively, less time may be spent on property creation. Additionally or alternatively, there may be less mistakes and/or inconsistencies in specification properties in comparison to manual creation of the specification properties. Additionally or alternatively, there may be less specification properties that are redundant and do not provide value-add. Additionally or alternatively, it may be easier to understand properties as they refer to the elements of the visual model instead of the verification model. Additionally or alternatively, novice users may not be required to learn new concepts, such as CTL and PSL, in order to verify their model.

In some exemplary embodiments, the disclosed subject matter may support CTL and PSL languages useful for advanced users.

Yet another technical effect is that instead of having a designer and a verification engineer work on the same model, the designer may work alone to verify the model. The information gap between the person designing the model and the person verifying the model, which may require information transfer, such as using documentation or meetings, may be eliminated.

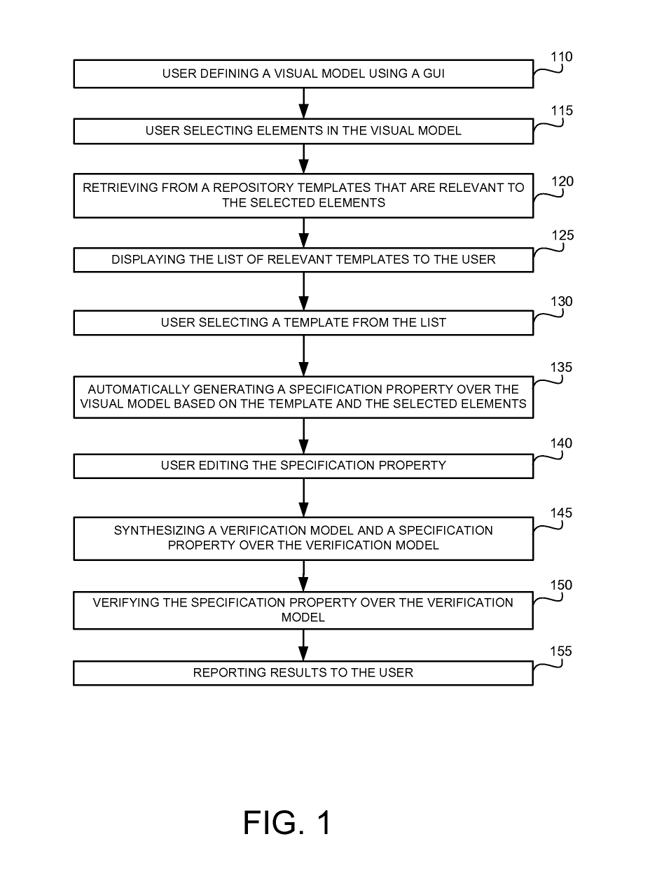

Referring now to FIG. 1 showing a method, in accordance with some exemplary embodiments of the disclosed subject matter.

In Step 110, a user, such as designer, may define a visual model describing a system. The user may define the visual model using a modeling tool having a GUI. The user may use, for example, diagrams to define different aspects of the system. In some exemplary embodiments, the system may be a software-implemented system.

The user defining the model may be a novice user or a user who is not proficient with verification-specific knowledge. Alternatively, the user may be proficient in the verification process and may still make use of the disclosed subject matter, such as to avoid redundant specification properties, mistakes and inconsistencies, to define properties in less time and effort, or the like.

In Step 115, the user may select elements in the visual model. The user may select, for example, a state of an entity depicted in a state diagram, a transition between states in a state diagram, an attribute of an entity depicted in a class diagram, a global variable defined for a package of the model, a sequence diagram of the model, activities, a state machine of an entity, or the like. The user may use a pointing device, such as a mouse or touch screen, to select the elements in the visual model. The selection may be performed, for example, based on mouse hover action, clicking action, or the like. It will be understood that the user may select any number of elements and may also select a single element.

In Step 120, based on the selected elements, a repository retaining specification property templates may be examined to retrieve templates that are relevant to the selected elements. The templates may be parameterized templates and may each be associated with different number and types of parameters. For example, a template for a mutual exclusion property template may be associated with at least two states. Any selection involving two or more states and no additional elements that are not states, may be considered relevant to such template. As another example, a reachability template, configured to make sure that one or more states are reachable, may be associated with one or more states. In some exemplary embodiments, the reachability template may still be deemed as relevant if non-state elements are also selected. Such elements may be used to define a constraint for the reachability template. As yet another example, a template making sure that a sequence never occurs may be deemed as relevant with respect to a selection of a sequence diagram. As can be appreciated from the above mentioned examples, each template may be configured to be relevant for a different set of selected elements. In some cases, if a selected element is not associated with any parameter of the template, the template may be considered as irrelevant for the selected elements.

In some exemplary embodiments, Step 120 may occur in response to an instruction from a user, such as an instruction to generate a specification property based on the selected elements.

In Step 125, the list of relevant templates may be displayed to the user who may select a template from the list (Step 130). In some exemplary embodiments, in case the list contains only a single selection, Steps 125 and 130 may be skipped.

In Step 135, the computer may automatically generate a specification property over the visual model. The specification property may be generated based on the selected template. The selected elements may be used as the parameters of the specification property.

It will be understood that the specification property may refer to elements of the visual model and not to the representation thereof in a verification model. As an example only, consider a mutual exclusion property relating to two states of two objects requiring that the two objects will not be at the two states at the same time. The verification model may include, for example, a signal for each object indicating a state of the object at the current cycle of the model. A mutual exclusion specification property over the verification model may make use of such signals, such as to make sure that at the same cycle, the two objects are not at the two states. However, the specification property over the visual model may not refer to such a signal, which is an implementation detail in a synthesized verification model of the visual model.

In Step 140, a user may edit the specification property. In some exemplary embodiments, the specification property may include a constraint or a similar Boolean expression defined over elements of the model. The user may edit the generated specification property to introduce relationships between the elements. As an example, consider the following template specification property of an invariant in the system: always <Boolean Expression>. Based on a selection by the user of attribute x1 of object obj1, selection of the idle state of object obj2, based on a selection of the global variable Top.globalVar and of the limit attribute of object obj3, the specification property may be generated in an incomplete manner, such as for example: always (obj1.×1 [?] state(obj2) [?] Idle [?] Top.globalVar [?] obj3.limit). The user may then edit the property to replace the [?] symbols with operators, values, parenthesis or the like. The user may also modify the order of the elements in the Boolean expression, which may be initially based on the order of the selection of elements by the user. As an example, the user may define the following specification property: always ((obj1.×1>5 && state(obj2)!=Idle)->(Top.globalVar<obj3 limit)), indicating that if the value of attribute x1 of object obj1 is greater than 5 and the object obj2 is in idle state, then it is implied that Top.globalVar is smaller than the value of the limit attribute of object obj3.

In some exemplary embodiments, the user may not manually edit the generated property and may utilize the property as generated.

In Step 145, based on the visual model, a verification model may be synthesized. The verification model may be synthesized in a verification language that is used by an available verification tool. In some exemplary embodiments, the visual model may first transformed using a chain of transformations to provide for a transformed visual model useful for the synthesis, such that is in line with requirements derived from the implementation details of the verification model, from the limitations of the language used for describing the verification model, or the like. The verification model may be synthesized based on the transformed visual model.

Based on the specification property over the visual model, a specification property may be created over the verification model introducing into the specification properties signals and other items that are comprised by the verification model but not the visual model. In some exemplary embodiments, variables, attributes or other elements of the visual model may be each mapped to one or more signals of the verification model. The specification property created in Step 145 may be defined over the mapped signals.

In some exemplary embodiments, the specification property over the verification model may depend upon implementation details of the synthesis of the verification model. It will be noted that different manner of synthesizing the model may be used and each may include different implementation details that may be referred to in the specification property that is over the verification model. The user may be indifferent to the implementation details in defining the specification properties over the visual model though such details should be taken into consideration if the specification property is defined over the verification model.

The specification property of Step 145 may be defined in a language useful for the available verification tool, such as for example PSL. It will be noted that the specification property over the visual model may be defined using a different language.

In Step 150, the verification model may be verified with respect to the specification property of Step 145. The verification may be performed using a verification tool, such as but not limited to symbolic model checker, explicit model checker, test generator, simulation-based validation platform, or the like.

In Step 155, the result of the verification process may be reported to the user, such as for example, reporting counter-examples exemplifying refutation of the specification property, indicating whether the property is held by the model, or the like.

In some exemplary embodiments, the method of FIG. 1 may be performed with respect to a plurality of properties which may be verified at the same time. The report may indicate status of each property and optionally including statuses of properties that were examined in the past as well.

In some exemplary embodiments, during the specification property definition stages of FIG. 1, the user may define which portions of the model will be included in the verification model and which portions will become part of the environment of the verification model. In such a manner, the verification process may be feasible in large models that may be subject to a state-space explosion problem or other models that may face similar feasibility barrier. In some exemplary embodiments, the selection of the model and the environment may be performed using the GUI of the modeling tool, such as by clicking on the elements to include or exclude them from the verification model. Furthermore, the user may define constraints over the verification model in by selecting elements in the GUI and using the selected elements to define a constraint over the environment.

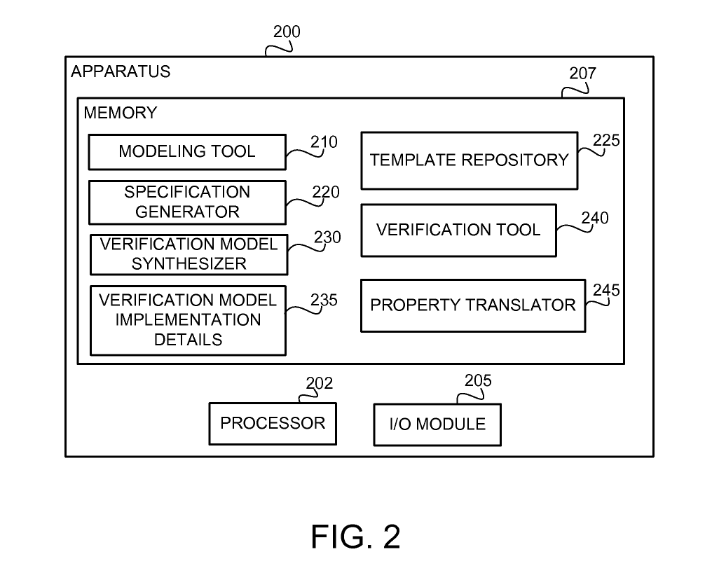

Referring now to FIG. 2 showing a block diagram of a machine, in accordance with some exemplary embodiments of the disclosed subject matter.

An Apparatus 200, such as performing steps of methods depicted in FIG. 2, may be configured to automatically generate and utilize a specification property over the visual model. Apparatus 200 may further be configured to synthesize a verification model based on a visual model, verify the verification model with respect to an adapted specification property that is defined over the verification model, and report to a user the results of the verification process.

In some exemplary embodiments a Processor 202 may be a Central Processing Unit (CPU), a microprocessor, an electronic circuit, an Integrated Circuit (IC) or the like. Processor 202 may be utilized to perform computations required by Apparatus 200 or any of it subcomponents. Processor 202 may be configured to execute computer-programs useful in performing the method of FIG. 1.

In some exemplary embodiments, an Input/Output (I/O) Module 205 may be configured to provide an output to and receive input from a user. In some exemplary embodiments, I/O Module 205 may be utilized to obtain user input instructions useful in defining the visual model, such as keyboard input, input from a pointing device, or the like.

In some exemplary embodiments, a Memory Unit 207 may be a short-term storage device or long-term storage device. Memory Unit 207 may be a persistent storage or volatile storage. Memory Unit 307 may be a disk drive, a Flash disk, a Random Access Memory (RAM), a memory chip, or the like. In some exemplary embodiments, Memory Unit 207 may retain program code operative to cause Processor 202 to perform acts associated with any of the subcomponents of Apparatus 200. In some exemplary embodiments, Memory Unit 207 may retain program code operative to cause Processor 202 to perform acts associated with any of the steps shown in FIG. 1 above. Memory Unit 307 may be used to retain visual models, generated or edited specification properties, verification models, verification results, or the like.

The components detailed below may be implemented as one or more sets of interrelated computer instructions, executed for example by Processor 202 or by another processor. The components may be arranged as one or more executable files, dynamic libraries, static libraries, methods, functions, services, or the like, programmed in any programming language and under any computing environment.

Modeling Tool 210 may be a computerized tool having a GUI that is used by a user to design a visual model. One example of such as tool is Rhapsody™ that enables a user to define a UML model of a system. The GUI may be useful to display to the user the visual model, including the content of diagrams thereof. It will be understood that the disclosed subject matter may be implemented as a plug-in, add-on, or similar extension of an off-the-shelf modeling tool.

Specification Generator 220 may be configured to generate a specification property over the visual model in view the user selection of elements of the visual model. Specification Generator 220 may determine selected elements, and based thereof perform a query in a Template Repository 225. Template Repository 225 may retain parameterized templates of specification properties. The query may retrieve from Repository 225 relevant templates to the user selection, such as templates for which the selected elements can be used as the parameters. In some exemplary embodiments, some parameters may be mandatory. In such a case, if the selection is not in accordance with all mandatory parameters the template is not deemed relevant. In some exemplary embodiments, some parameters may be optional. In such a case, if the selection may be relevant although some or all of the optional parameters are not accounted for by the user selection.

In some exemplary embodiments, the user may edit the generated specification property. The user may edit the specification property in a manual or semi-manual manner (e.g., using GUI elements providing predetermined operations).

Verification Model Synthesizer 230 may be configured to synthesize a verification model based on the visual model. The synthesis may depend upon Verification Model Implementation Details (VMID) 235. VMID 235 may include implementation details on how to generate the verification model and may mapping information and added signals to the verification model that are inherent in the visual model. As an example, the verification model may model each cycle of the visual model using two cycles of the verification model. The implementation details may be adapted to provide for an efficient and successful verification process, such as avoiding the state-space explosion problem, representing the model in a manner best suited for the Verification Tool 240 being used, or the like. As an example only, a different modeling may be used for synthesizing a verification model for a Binary Decision Diagram (BDD)-based model checker than that for a SAT-based model checker. A different model may be synthesized for a simulator. In some exemplary embodiments, the difference between the verification models may not be due to the use of a different language (e.g., GDL, SystemC, or the like).

Property translator 245 may be configured to translate the specification property over the visual model to be over the verification model. The translation may take into account the implementation details used for synthesizing the verification model. In some exemplary embodiments, Property Translator 245 may translate the property to a property language used by the Verification Tool 240.

Verification Tool 240 may be configured to verify that the verification model holds the specification property. Verification Tool 240 may be, for example, a model checker, a theorem prover, a simulator, an assertion checker, or the like.

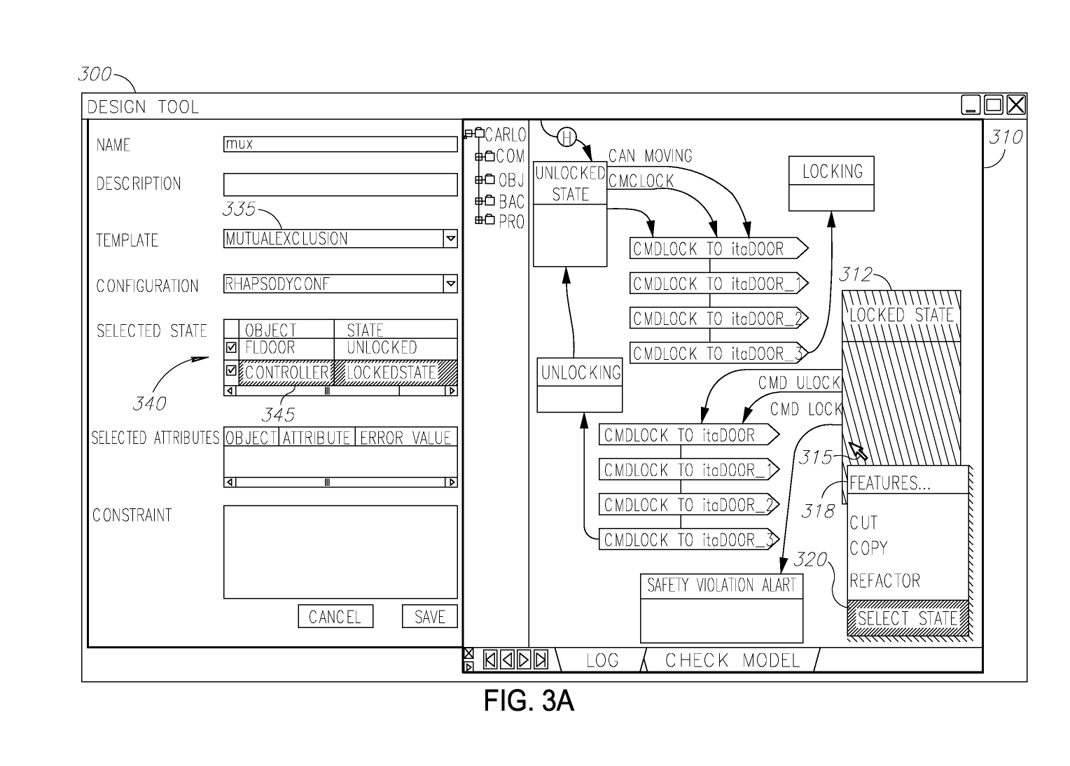

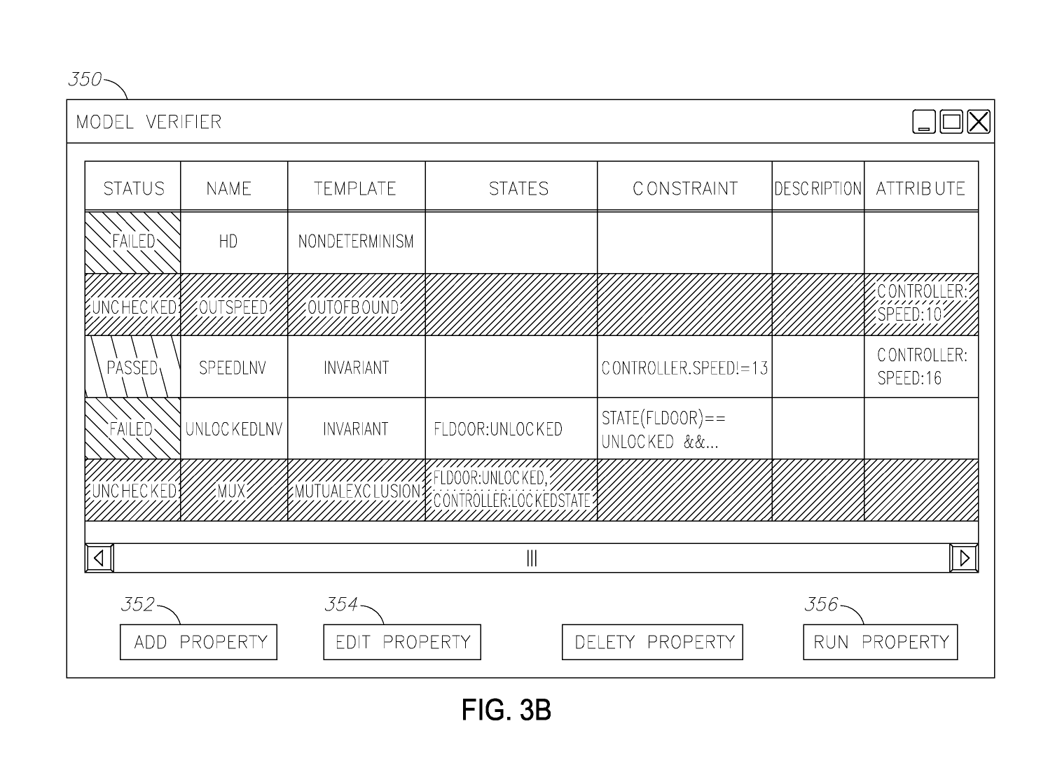

Referring now to FIG. 3A showing an illustration of a GUI, in accordance with some exemplary embodiments of the disclosed subject matter.

A GUI 300 provides a user with a graphical interface for modeling a visual model. Pane 310 displays a diagram of the visual model. The user may select a diagram to be displayed in Pane 310 from the plurality of diagrams of the visual model.

Additionally or alternatively, the user may add a new diagram to the visual model to be displayed in Pane 310 while being edited.

Using a pointing device, the user may select Element 312 in Pane 310. The user may utilize a Cursor 315 to point to Element 312. Element 312 may be a state of an object depicted in the state diagram currently being displayed in Pane 310.

In some exemplary embodiments, selection of Element 312 may be performed using a Context Menu 318 listing operations applicable to the selected element (Element 312). One such operation is Operation 320: “Select State” which may be useful for selecting Element 312 to be used in a definition of a specification property over the visual model.

In some exemplary embodiments, the user may select elements by clicking the elements using Cursor 315. Additionally or alternatively, the user may select a plurality of elements, such as by clicking on the elements one after another and holding the CTRL button, or using other combinations of inputs to the GUI 300.

Pane 330 may include a form associated with generation of a property specification in accordance with the disclosed subject matter. In Pane 330, the user may define a name for the specification property. Pane 330 may list all selected elements. In some exemplary embodiments, the elements may initially be displayed in accordance to an order of selection. The user may modify the order of the elements. As can be appreciated from Pane 340, selected elements of type “state” may be displayed in Table 340. Table 340 displays for each selected state information regarding the selected state, such as name of the state as defined in the visual model, object in which the state occurs, or the like. In response to the selection by the user, State 312 is introduced to Table 340 and is displayed in Record 345.

List 335 provides a set of templates from which the user can chose. The list of templates may be provided based on the template repository. In some exemplary embodiments, List 335 includes only templates which can be generated based on the elements selected by the user. In this example, MutualExclusion template is valid template as the user selected more than two states.

In some exemplary embodiments, the template may include a Boolean expression which may be edited by the user using Field 347. The user may edit the expression to define, add or modify a constraint, a relationship between elements, a constant value, or a similar item useful in the expression.

Referring now to FIG. 3B showing an illustration of a GUI, in accordance with some exemplary embodiments of the disclosed subject matter. Pane 350 allows the user to control the verification process of the visual model. The user may decide to add a new specification property (Add Button 352) and use the GUI illustrated in FIG. 3A for such a purpose. The user may edit an existing property and modify it to change the selected elements, the constraint, the template or the like (Edit Button 354).

The user may use Pane 350 to select one or more properties to be verified and may instruct the tool to perform the verification of the properties, such as using the Run Button 356. In response to such instruction, the tool may synthesize a verification model (or use a previously synthesized version of the model in case the model was not modified since), translate the specification properties to be over the verification model instead of over the visual model and be provided in a suitable specification language such as PSL. The tool may further execute a verification tool, such as a model checker, to verify the properties with respect to the specification property. In some exemplary embodiments. Pane 350 may provide a report to the user on the results of the verification process, such as by indicating with respect to each property whether it passed or failed. The report may also indicate which properties were not yet checked and for which properties the verification process encountered a technical error not allowing the process to complete. In some exemplary embodiments, with respect to properties that have failed, the user may instruct the tool to exemplify the failure using a counter-example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising automatically generating, by a processor, a specification property for a verification model based on a selection by a user of at least one element in a visual model, wherein the visual model defines a computerized system, wherein the verification model corresponds to the visual model.

2. The computer-implemented method of claim 1, wherein the selection is performed in a Graphical User Interface (GUI) of a visual modeling tool used for designing the visual model.

3. The computer-implemented method of claim 1, wherein in response to the selection, retrieving from a template repository a specification property template relevant to the selection; and wherein said automatically generating is based on the specification property template.

4. The computer-implemented method of claim 1, further comprising:
in response to the selection, retrieving from a template repository a plurality of relevant specification property templates;
presenting to the user using a Graphical User Interface (GUI) the plurality of relevant specification property templates; and
in response to a second selection by the user of a selected specification property template from the plurality of relevant specification property templates, generating the specification property based on the selected specification property template.

5. The computer-implemented method of claim 1, wherein the at least one element is selected from the group consisting of: a state of an entity, a transition between states of entities, an attribute of an entity, a state machine of an entity, a sequence diagram and a class.

6. The computer-implemented method of claim 1 further comprising: automatically synthesizing the verification model based on the visual model; and verifying the verification model with respect to the specification property.

7. The computer-implemented method of claim 1, wherein the visual model is a Unified Modeling Language (UML) model of a software system, whereby the user is enabled to define a specification property over the UML model.

8. The computer-implemented method of claim 1, wherein the selection by the user is a selection of a plurality of states associated with a plurality of entities, and the specification property is a mutual exclusion specification property with respect to the plurality of states.

9. The computer-implemented method of claim 1, wherein the specification property is an invariant specification property associated with a constraint, wherein the constraint is defined based on the selected at least one element.

10. The computer-implemented method of claim 1, wherein the selection by the user is a selection of a state, and the specification property is a reachability specification property with respect to the state.

11. The computer-implemented method of claim 1, wherein the selection by the user is a selection of a sequence element, and the specification property is a temporal specification property associated with the sequence element.

12. A system having a processor, the processor being adapted to perform the steps of:
automatically generating, by a processor, a specification property for a verification model based on a selection by a user of at least one element in a visual model, wherein the visual model defines a computerized system, wherein the verification model corresponds to the visual model.

13. The system of claim 12, wherein the selection is performed in a Graphical User Interface (GUI) of a visual modeling tool used for designing the visual model.

14. The system of claim 12, wherein the processor is adapted to retrieve from a template repository a specification property template relevant to the selection in response to the selection; and wherein said automatically generating is based on the specification property template.

15. The system of claim 12, wherein the processor is adapted to:
in response to the selection, retrieve from a template repository a plurality of relevant specification property templates;
present to the user using a Graphical User Interface (GUI) the plurality of relevant specification property templates; and
in response to a second selection by the user of a selected specification property template from the plurality of relevant specification property templates, generate the specification property based on the selected specification property template.

16. The system of claim 12, wherein the processor is further adapted to: automatically synthesize the verification model based on the visual model; and verify the verification model with respect to the specification property.

17. The system of claim 12, wherein the visual model is a Unified Modeling Language (UML) model of a software system, whereby the user is enabled to define a specification property over the UML model.

18. A computer program product comprising a non-transitory computer readable medium retaining program instructions, which instructions when read by a processor, cause the processor to perform a method comprising:
automatically generating, by a processor, a specification property for a verification model based on a selection by a user of at least one element in a visual model, wherein the visual model defines a computerized system, wherein the verification model corresponds to the visual model.
